(19) United States
(12) Patent Application Publication
(10) Pub. No.: US 2010/0042640 A1
(43) Pub. Date: Feb. 18, 2010

(54) Migration Apparatus Which Convert SAM/VSAM Files of Mainframe System into SAM/VSAM Files of Open System and Method for Thereof

(75) Inventors: Kang Ho Lee, Seoul (KR); Min Ho Lee, Seoul (KR); Ki Jin Park, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: SAMSUNG SDS CO., LTD., Seoul (KR)

(21) Appl. No.: 12/445,568

(22) PCT Filed: Dec. 8, 2006
(86) PCT No.: PCT/KR06/05332

§ 371 Date: Oct. 21, 2009

(30) Foreign Application Priority Data
Oct. 17, 2006 (KR) 10-2006-0100805

(51) Int. Cl. G06F 7/00; G06F 12/00

(52) U.S. Cl. 707/101; 707/204; 707/E17.01; 707/E17.044

(57) ABSTRACT

Provided are a migration apparatus and method for converting a sequential access method (SAM)/virtual storage access method (VSAM) file of a mainframe system into an appropriate SAM/VSAM file for an open system. The migration apparatus includes: an information obtaining module for obtaining various file information on a SAM file of the mainframe system; a data obtaining module for obtaining actual data of the SAM file of the mainframe system composed of Extended Binary Coded Decimal Interchange Code (EBCDIC) in binary format; a code conversion module for converting the obtained actual data composed of EBCDIC into American Standard Code for Information Interchange (ASCII) code; a file combination module for combining the obtained file information on the SAM file with the actual data corresponding to the file information and converted into ASCII code; and a file registration module for registering the file information of the combined SAM file in the open system. The migration apparatus and method efficiently reuse a conventionally used SAM/VSAM file during a rehosting process of converting a mainframe system into an open system.

### TECHNICAL FIELD

The present invention relates to a migration apparatus and method for reusing and converting a sequential access method (SAM)/virtual storage access method (VSAM) file used in a mainframe system into an appropriate SAM/VSAM file for an open system.

### BACKGROUND ART

In general, mainframe systems have been used to process data within large corporations and governmental organizations.

The term, mainframe system, is industrial terminology indicating a large-scale computer manufactured by a large company, e.g., IBM Corporation. Mainframe systems are mainly used for performing computations required for the business activities of large companies, such as large corporations and financial institutions, and are configured according to a centralized computing method rather than a distributed computing method.

The cost of such a mainframe system is high and rapidly increases every year. For this reason, mainframe system environments are recently being replaced by open system environments, e.g., UNIX or Linux, which are designed to enable linkage between hardware (H/W) and software (S/W) of different computer manufacturing companies, and so on.

However, totally reestablishing a conventionally used mainframe system environment as an open system environment is very costly and takes a long time.

To solve these problems, rehosting solutions have lately been developed which, when converting a mainframe system environment into an open system environment, do not reestablish the entire system but convert H/W and S/W in the conventional mainframe system environment into H/W and S/W in an open system environment using middleware, a compiler solution, etc., and reuse the H/W and S/W by a migration operation of an application program and data.

According to such rehosting solutions, however, during the migration operation for work files, e.g., a sequential access method (SAM) file, a virtual storage access method (VSAM) file, etc., of a company, many errors occur due to a difference in a code system applied to a mainframe system and an open system.

### DISCLOSURE OF INVENTION

### Technical Problem

The present invention is directed to a migration apparatus and method that minimize errors due to a difference in a code system and more rapidly convert a sequential access method (SAM)/virtual storage access method (VSAM) file of a mainframe system into an appropriate SAM/VSAM file for an open system.

### Technical Solution

One aspect of the present invention provides a migration apparatus for converting a sequential access method (SAM) file of a mainframe system into an appropriate SAM file for an open system, the migration apparatus comprising: an information obtaining module for obtaining various file information on a SAM file of the mainframe system; a data obtaining module for obtaining actual data of the SAM file of the mainframe system composed of Extended Binary Coded Decimal Interchange Code (EBCDIC) in binary format; a code conversion module for converting the obtained actual data composed of EBCDIC into American Standard Code for Information Interchange (ASCII) code; a file combination module for combining the obtained file information on the SAM file with the actual data corresponding to the file information and converted into ASCII code; and a file registration module for registering the file information of the combined SAM file in the open system.

Here, the mainframe system may be a mainframe environment of IBM Corporation, and the open system may be a UNIX environment.

The code conversion module may convert a character string including shift-outs (SOs) and shift-ins (SIs) by filling positions of the SOs and SIs with spaces or removing SOs and SIs numbering less than a number of attribute positions and disposing data between the SOs and the SIs in their original positions during code conversion.

The code conversion module may convert spaces or single-byte characters into single-byte ASCII code during code conversion.

The code conversion module may change a Korean character string/full-width character string having neither an SO nor an SI in double byte format by adding an SO and an SI to hexadecimal values of the character string composed of EBCDIC and convert the character string into ASCII code during code conversion.

Another aspect of the present invention provides a migration method for converting a virtual storage access method (VSAM) file of a mainframe system into an appropriate VSAM file for an open system, the migration apparatus comprising: an information obtaining module for obtaining various file information on a VSAM file of the mainframe system, the file information including index information; a data obtaining module for obtaining actual data of the VSAM file of the mainframe system composed of EBCDIC in binary format; a code conversion module for converting the obtained actual data composed of EBCDIC into ASCII code; a file combination module for combining the obtained various file information on the VSAM file with the actual data corresponding to the file information and converted into ASCII code, the file information including the index information; and a file registration module for registering the file information of the combined VSAM file in the open system.

Still another aspect of the present invention provides a migration method for converting a SAM file of a mainframe system into an appropriate SAM file for an open system, the migration method comprising the steps of: (a) obtaining various file information on a SAM file of the mainframe system; (b) obtaining actual data of the SAM file of the mainframe system composed of EBCDIC in binary format; (c) converting the obtained actual data composed of EBCDIC into ASCII code; (d) combining the obtained file information on the SAM file with the actual data corresponding to the file information and converted into ASCII code; and (e) registering the combined SAM file in the open system.

Yet another aspect of the present invention provides a migration method for converting a VSAM file of a mainframe system into an appropriate VSAM file for an open system, the migration method comprising the steps of: (a) obtaining various file information on a VSAM file of the mainframe system, the file information including index information; (b) obtaining actual data of the VSAM file of the mainframe system composed of EBCDIC in binary format; (c) converting the obtained actual data composed of EBCDIC into ASCII code; (d) combining the obtained various file information on the VSAM file with the actual data corresponding to the file information and converted into ASCII code, the file information including the index information; and (e) registering the combined VSAM file in the open system.

Still yet another aspect of the present invention provides a recording medium storing a program for executing the above-described migration method for converting a SAM/VSAM file of a mainframe system into an appropriate SAM/VSAM file for an open system.

### Advantageous Effects

According to the inventive migration apparatus and method for converting a sequential access method (SAM)/virtual storage access method (VSAM) file of a mainframe system into an appropriate SAM/VSAM file for an open system, it is possible to minimize errors due to a difference in a code system and more rapidly convert a SAM/VSAM file used in the mainframe system into an appropriate SAM/VSAM file for the open system.

It is also possible to efficiently reuse a conventionally used SAM/VSAM file via a rehosting process of converting a mainframe system into an open system.

### BRIEF DESCRIPTION OF THE DRAWINGS

FIG. 1 is a block diagram schematically illustrating a migration apparatus for converting a sequential access method (SAM)/virtual storage access method (VSAM) file of a mainframe system into an appropriate SAM/VSAM file for an open system according to an exemplary embodiment of the present invention; and

FIG. 2 is a flowchart illustrating a migration method for converting a SAM/VSAM file of a mainframe system into an appropriate SAM/VSAM file for an open system according to an exemplary embodiment of the present invention.

### MODE FOR THE INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

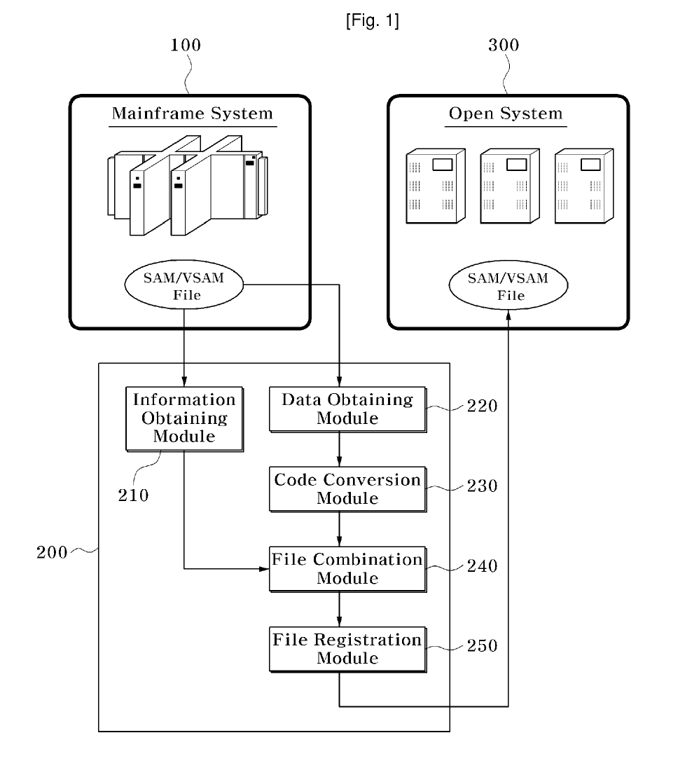

FIG. 1 is a block diagram schematically illustrating a migration apparatus for converting a sequential access method (SAM)/virtual storage access method (VSAM) file of a mainframe system into an appropriate SAM/VSAM file for an open system according to an exemplary embodiment of the present invention.

Referring to FIG. 1, a migration apparatus 200 that converts a work file, i.e., a SAM/VSAM file, used in a mainframe system 100 into an appropriate SAM/VSAM file for an open system 300 roughly comprises an information obtaining module 210, a data obtaining module 220, a code conversion module 230, a file combination module 240, and a file registration module 250.

Here, the mainframe system 100 processing company data is industrial terminology indicating a large scale computer manufactured by a large company, e.g., IBM Corporation. The mainframe system 100 is mainly used for performing computations required for the business activities of large companies, such as large corporations and financial institutions, and is configured according to a centralized computing method rather than a distributed computing method.

Meanwhile, the open system 300 is industrial terminology indicating a method designed for enabling a link between hardware (H/W) and software (S/W) of different computer manufacturing companies, and is capable of being classified according to operating system, communication technique, and so on. The open system 300 mentioned here is a medium-scale computer having an operating system, e.g., UNIX, Linux, etc.

The SAM file is generally created by a sequential access method, which accesses items of information in the order in which they are stored. Using this method, it is possible to estimate data to be loaded next. In general, the sequential access method is used for accessing a large quantity of data in series.

In other words, the sequential access method enables sequential recording or reading of data in/from consecutive, adjacent locations in a memory device.

The VSAM file is an indexed sequential file using a dynamic index method, indicating a data set comprising data segments and index segments rather than data alone. The index segments provide the index of data included in the data segments of the same data set.

The information obtaining module 210 functions to obtain various file information, e.g., catalog, layout length, attribute type, storage information, etc., on a SAM/VSAM file of the mainframe system 100. Here, in the case of a VSAM file, the file information further includes index information.

The data obtaining module 220 functions to obtain actual data of the SAM/VSAM file of the mainframe system 100 composed of Extended Binary Coded Decimal Interchange Code (EBCDIC), in binary format.

The code conversion module 230 functions to receive the actual data composed of EBCDIC obtained by the data obtaining module 220 and convert it into American Standard Code for Information Interchange (ASCII) code.

In addition, the code conversion module 230 functions to convert a character string including shift-outs (SOs) and shift-ins (SIs) by filling positions of the SOs and SIs with spaces or removing SOs and SIs numbering less than a number of attribute positions and disposing data between the SOs and the SIs in their original positions during code conversion.

In addition, the code conversion module 230 functions to convert spaces or single-byte characters into single-byte ASCII code during code conversion.

In addition, the code conversion module 230 functions to change a Korean character string/full-width character string having neither an SO nor an SI in double byte format by adding an SO and an SI to hexadecimal values of the character string composed of EBCDIC and convert the character string into ASCII code during code conversion.

The file combination module 240 functions to combine the file information on the SAM/VSAM file obtained from the information obtaining module 210 with the actual data corresponding to the file information and converted into ASCII code by the code conversion module 230.

The file registration module 250 functions to receive the combined SAM/VSAM file from the file combination module 240 and register the file information, e.g., catalog, etc., in the open system 300.

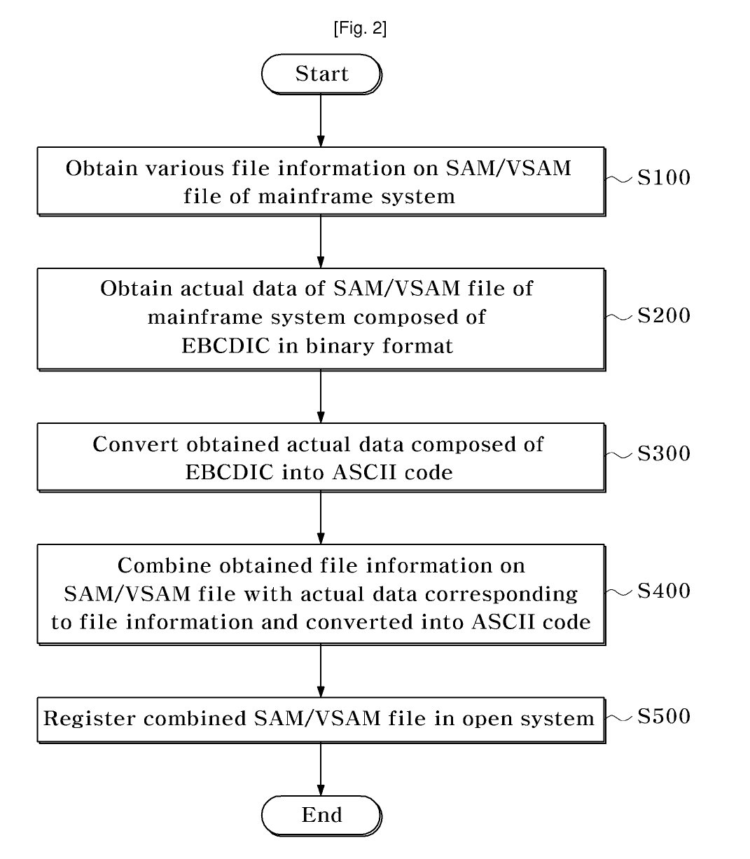

FIG. 2 is a flowchart illustrating a migration method for converting a SAM/VSAM file of a mainframe system into an appropriate SAM/VSAM file for an open system according to an exemplary embodiment of the present invention.

Referring to FIGS. 1 and 2, first, various file information, e.g., catalog, layout length, attribute type, storage information, etc., on a SAM/VSAM file of the mainframe system 100 is obtained by the information obtaining module 210 (step 100). Here, in the case of a VSAM file, index information is further obtained.

Then, actual data of the SAM/VSAM file of the mainframe system 100 composed of EBCDIC is obtained in binary format by the data obtaining module 210 (step 200).

Subsequently, the actual data composed of EBCDIC obtained in step 200 is converted into ASCII code by the code conversion module 230 (step 300).

Here, during code conversion, a character string including SOs and SIs is converted by filling positions of the SOs and SIs with spaces or removing SOs and SIs numbering less than the number of attribute positions and disposing data between the SOs and the SIs in their original positions.

In addition, during code conversion, spaces or single-byte characters are converted into single-byte ASCII code.

In addition, during code conversion, a Korean character string/full-width character string having neither an SO nor an SI is changed in double byte format by adding an SO and an SI to hexadecimal values of the character string composed of EBCDIC and converted into ASCII code.

Subsequently, by the file combination module 240, the file information on the SAM/VSAM file obtained in step 100 is combined with the actual data corresponding to the file information and converted into ASCII code in step 300 (step 400).

Finally, the SAM/VSAM file combined in step 400 is registered in the open system 300 by the file registration module 250 (step 500).

Meanwhile, the migration method for converting a SAM/VSAM file of a mainframe system into an appropriate SAM/VSAM file for an open system according to an exemplary embodiment of the present invention can be stored on a computer-readable recording medium in the form of computer code. The computer-readable recording medium may be any recording device storing data that can be read by computer systems.

For example, the computer-readable recording medium may be a read-only memory (ROM), a random-access memory (RAM), a compact disk read-only memory (CD-ROM), a magnetic tape, a hard disk, a floppy disk, a mobile storage device, a nonvolatile memory (flash memory), an optical data storage device, and so on. Also, the recording medium may be carrier waves, e.g., transmission over the Internet.

In addition, the computer-readable recording medium may be distributed among computer systems connected via a communication network and stored in the form of a code that can be read and executed by a de-centralized method.

While the invention has been shown and described with reference to certain exemplary embodiments of a migration apparatus and method for converting a SAM/VSAM file of a mainframe system into an appropriate SAM/VSAM file for an open system, it will be understood by those skilled in the art that various changes in form and details may be made therein without departing from the spirit and scope of the invention as defined by the appended claims.

1. A migration apparatus for converting a sequential access method (SAM) file of a mainframe system into an appropriate SAM file for an open system, the apparatus comprising:
an information obtaining module for obtaining various file information on a SAM file of the mainframe system;
a data obtaining module for obtaining actual data of the SAM file of the mainframe system composed of Extended Binary Coded Decimal Interchange Code (EBCDIC) in binary format;
a code conversion module for converting the obtained actual data composed of EBCDIC into American Standard Code for Information Interchange (ASCII) code;
a file combination module for combining the obtained file information on the SAM file with the actual data corresponding to the file information and converted into ASCII code; and
a file registration module for registering the file information of the combined SAM file in the open system.

2. The migration apparatus of claim 1, wherein the mainframe system is a mainframe environment of IBM Corporation, and the open system is a UNIX environment.

3. The migration apparatus of claim 1, wherein the code conversion module converts a character string including shift-outs (SOs) and shift-ins (SIs) by filling positions of the SOs and SIs with spaces or removing SOs and SIs numbering less than a number of attribute positions and disposing data between the SOs and the SIs in their original positions.

4. The migration apparatus of claim 1, wherein the code conversion module converts spaces or single-byte characters into single-byte ASCII code during code conversion.

5. The migration apparatus of claim 1, wherein the code conversion module changes a Korean character string/full-width character string having neither a shift-out (SO) nor a shift-in (SI) in double byte format by adding an SO and an SI to hexadecimal values of the character string composed of EBCDIC and converts the character string into ASCII code.

6. A migration apparatus for converting a virtual storage access method (VSAM) file of a mainframe system into an appropriate VSAM file for an open system, the apparatus comprising:
an information obtaining module for obtaining various file information on a
VSAM file of the mainframe system, the file information including index information;
a data obtaining module for obtaining actual data of the VSAM file of the mainframe system composed of Extended Binary Coded Decimal Interchange Code (EBCDIC) in binary format;
a code conversion module for converting the obtained actual data composed of EBCDIC into American Standard Code for Information Interchange (ASCII) code;
a file combination module for combining the obtained various file information on the VSAM file with the actual data corresponding to the file information and converted into ASCII code, the file information including the index information; and
a file registration module for registering the file information of the combined VSAM file in the open system.

7. A migration method for converting a sequential access method (SAM) file of a mainframe system into an appropriate SAM file for an open system, the method comprising the steps of:
(a) obtaining various file information on a SAM file of the mainframe system;
(b) obtaining actual data of the SAM file of the mainframe system composed of Extended Binary Coded Decimal Interchange Code (EBCDIC) in binary format;
(c) converting the obtained actual data composed of EBCDIC into American Standard Code for Information Interchange (ASCII) code;
(d) combining the obtained file information on the SAM file with the actual data corresponding to the file information and converted into ASCII code; and
(e) registering the combined SAM file in the open system.

8. The method of claim 7, wherein in step (c), a character string including shift-outs (SOs) and shift-ins (SIs) is converted by filling positions of the SOs and SIs with spaces or removing SOs and SIs numbering less than a number of attribute positions and disposing data between the SOs and the SIs in their original positions during code conversion.

9. The method of claim 7, wherein in step (c), spaces or single-byte characters are converted into single-byte ASCII code during code conversion.

10. The method of claim 7, wherein in step (c), a Korean character string/full-width character string having neither a shift-out (SO) nor a shift-in (SI) is changed in double byte format by adding an SO and an SI to hexadecimal values of the character string composed of EBCDIC and converted into ASCII code during code conversion.

11. A migration method for converting a virtual storage access method (VSAM) file of a mainframe system into an appropriate VSAM file for an open system, the method comprising the steps of:
(a) obtaining various file information on a VSAM file of the mainframe system, the file information including index information;
(b) obtaining actual data of the VSAM file of the mainframe system composed of Extended Binary Coded Decimal Interchange Code (EBCDIC) in binary format;
(c) converting the obtained actual data composed of EBCDIC into American Standard Code for Information Interchange (ASCII) code;
(d) combining the obtained various file information on the VSAM file with the actual data corresponding to the file information and converted into ASCII code, the file information including the index information; and
(e) registering the combined VSAM file in the open system.

12. A computer-readable recording medium storing a program capable of executing the migration method of any one of claims 7 to 11.
